(19) United States
(12) Patent Application Publication
(10) Pub. No.: US 2023/0302394 A1
(43) Pub. Date: Sep. 28, 2023

(54) Atmospheric Water And Carbon Dioxide Harvesting For Farming

(71) Applicant: Water Harvesting, Inc., Newark, CA (US)

(72) Inventors: Bruno Marchon, Palo Alto, CA (US); Eugene A. Kapustin, Berkeley, CA (US)

(73) Assignee: Water Harvesting, Inc., Newark, CA (US)

(21) Appl. No.: 18/022,094

(22) PCT Filed: Aug. 25, 2021
(86) PCT No.: PCT/US2021/047491

§ 371 Date: Feb. 17, 2023

Related U.S. Application Data
(60) Provisional application No. 63/072,525, filed on Aug. 31, 2020.

(51) Int. Cl. B01D 53/04; B01D 53/26; B01D 53/28; A01G 7/02; A01G 25/00

(52) U.S. Cl. CPC B01D 53/0438; B01D 53/261; B01D 53/28; B01D 53/0454; A01G 7/02; A01G 25/00; B01D 2253/204; B01D 2257/80; B01D 2257/504; B01D 2258/06; B01D 2259/40088

(57) ABSTRACT

Provided herein are water and carbon dioxide harvesting systems, as well as methods using such systems, for capturing water and carbon dioxide from surrounding air. The systems and methods use water capture materials to adsorb water from the air and carbon dioxide capture materials to adsorb carbon dioxide from the air. For example, the water and carbon dioxide capture materials may be metal-organic-frameworks. The systems and methods desorb the water in the form of water vapor and the carbon dioxide. The water vapor is then condensed into liquid water. The water and carbon dioxide generated can be used in farming systems, including hydroponics and vertical farming systems.

### CROSS-REFERENCE TO RELATED APPLICATION

0.1 This application claims priority to U.S. Provisional Patent Application No. 63/072,525, filed Aug. 31, 2020, which is incorporated herein by reference in its entirety.

### FIELD

The present disclosure relates generally to farming, and more specifically to atmospheric water and carbon dioxide harvesting systems suitable for integration into farming.

### BACKGROUND

Water is scarce, especially in desert areas of North Africa and the Middle East. For this reason, conventional farming, requiring large amount of irrigation is often prohibitive. Hydroponics methods in green-house structures offer higher yields and water efficiencies, although the ratio of water-to-lettuce is still high. Vertical farming goes one step further, where leafy greens are grown on stacked shelves in large buildings, with controlled atmospheric conditions (e.g., temperature, humidity), and light being supplied by arrays of LED bulbs.

In order for plants to grow, not just water and light are needed. Plants in fact rely on atmospheric carbon dioxide as an essential component of photosynthesis, according to the following reaction:

6CO₂+6H₂O→C₆H₁₂O₆+6O₂ Eq(1)

In hydroponics and/or vertical farming, plants are also supplied with small amounts of mineral nutrients (e.g., phosphorus, nitrogen, iron, potassium). Today's hydroponics and vertical farming are also concerned about space utilization (e.g., urban areas) and cold weather with low insolation, in addition to the supply of fresh water. One issue is the high consumption of carbon dioxide, necessitating a constant exchange with outside air. This results in high heating cost, and waste of water/humidity. In some cases, pure carbon dioxide gas in injected into the building as a feed gas, but this comes at a significant cost as well. In urban areas, pure carbon dioxide is usually supplied by large trucks, but in remote, desert areas, this would be prohibitive proposition.

Thus, what is desired in the art are alternative systems that can provide both water and carbon dioxide to hydroponics and vertical farming.

### BRIEF SUMMARY

In some aspects, provided is a farming system relying on renewal energy (e.g., solar, wind), where water and carbon dioxide are harvested from ambient air. In some variations, the system relies solely on renewable energy.

In certain aspects, provided is an atmospheric harvester, comprising: at least one unit containing water capture material, carbon dioxide capture material, or both, from surrounding air. When the system operates in adsorption mode, the at least one unit containing water capture material is configured to adsorb moisture from the air, and the at least one unit containing carbon dioxide capture material is configured to adsorb carbon dioxide from the air. When the system operates in production mode, the at least one unit containing water capture material is configured to desorb water vapor form the water capture material, the at least one unit containing carbon dioxide capture material is configured to desorb carbon dioxide from the carbon dioxide capture material. In some embodiments, the system is configured to condense the water vapor into liquid water, and optionally, cool the carbon dioxide.

In some embodiments, the atmospheric harvester comprises: at least one atmospheric water harvesting unit containing the water capture material; and at least one atmospheric carbon dioxide harvesting unit containing carbon dioxide capture material. In some variations, the water capture material and the carbon dioxide capture material independently comprise metal-organic frameworks.

In some variations of the foregoing, the atmospheric harvester further comprises one or more additional components, including for example, a heating element, a condensing unit, a vacuum pump, a control system, or a power source.

In certain aspects, provided is an integrated farming system comprising: any of the atmospheric harvesters described herein, configured to release water and carbon dioxide harvested from surrounding air into a farming system. In some embodiments, the farming system further comprises an oxygen reduction unit, such as an oxygen-permeable membrane, living organisms with oxygen-consuming metabolism and that produce proteins, or fuel such that the unit is configured to convert oxygen to carbon dioxide by combustion, or any combination thereof.

In other aspects, provided is a method of harvesting water and carbon dioxide from surrounding air using any of the atmospheric harvesters described herein. In some embodiments, the method comprises: adsorbing moisture from air in the at least one unit containing water capture material, and adsorbing carbon dioxide from air in the at least one unit containing carbon dioxide capture material; desorbing water vapor from the water capture material in the at least one unit containing water capture material, and desorbing carbon dioxide from the carbon dioxide capture material in the at least one unit containing carbon dioxide capture material; condensing the water vapor to produce liquid water: and, optionally, cooling the carbon dioxide.

In yet other aspects, provided is a method of farming, comprising: providing water and carbon dioxide harvested from surrounding air to a farming system, in which the water and carbon dioxide are harvested according to any of the methods for harvesting described herein; and growing crops in the farming system. In some embodiments, the methods provided further comprise: reducing or eliminating oxygen from air inside the farming system.

The present application can be understood by reference to the following description taken in conjunction with the accompanying figures.

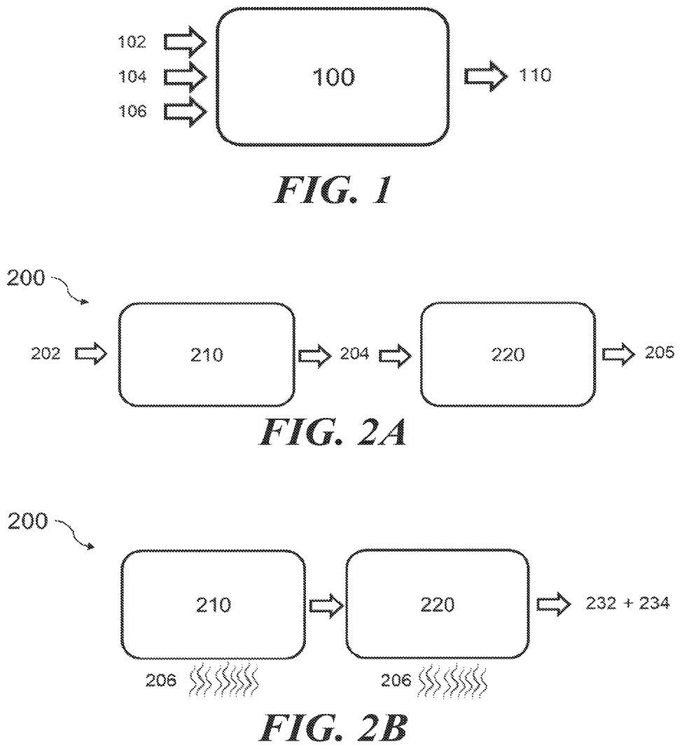

FIG. 1 depicts the schematics of the inputs and outputs for an exemplary vertical farm system of the present disclosure.

FIGS. 2A and 2B depict the schematics of the simultaneous water and carbon dioxide capture in the adsorption and desorption phases, respectively.

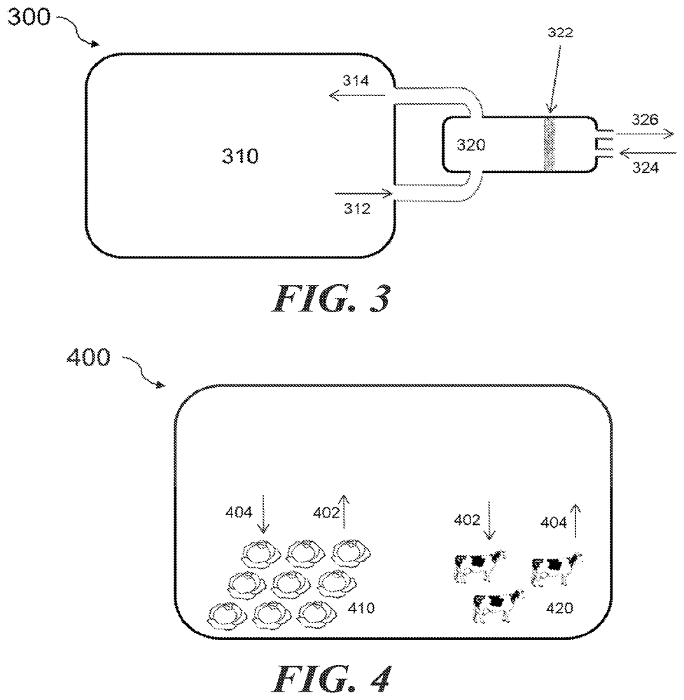

FIG. 3 depicts an exemplary membrane-based oxygen exchanger for use in oxygen reduction or elimination.

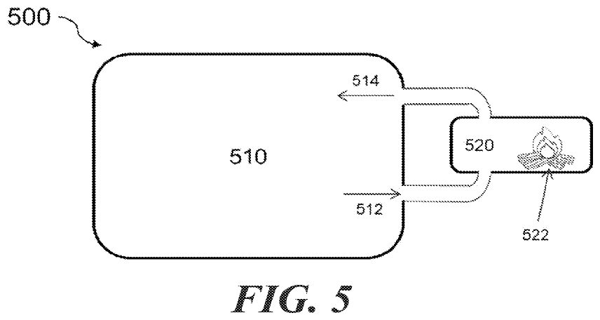

FIG. 4 depicts oxygen reduction or elimination using animals.

FIG. 5 depicts oxygen reduction or elimination using combustion.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

In some aspects, provided is an atmospheric harvester that captures water and carbon dioxide from ambient air. In some embodiments, such atmospheric harvester is integrated in a farming system, such as hydroponics and/or vertical farming. For example, the atmospheric harvesters described herein may be incorporated into a vertical farming system, such as exemplary system 100 depicted in FIG. 1. System 100 takes inputs, such as air 102, nutrients 104, and energy 106, and outputs vegetables 110.

### Atmospheric Harvester

In some embodiments, the atmospheric harvester comprises at least one unit containing water capture material, carbon dioxide capture material, or both. In certain embodiments, the atmospheric harvester comprises: at least one atmospheric water harvesting unit containing the water capture material, and at least one atmospheric carbon dioxide harvesting unit containing carbon dioxide capture material. In other embodiments, the atmospheric harvester comprises at least one unit containing a mixture of water capture material and carbon dioxide capture material, configured to simultaneously capture water and carbon dioxide.

With reference to FIGS. 2A and 2B, an exemplary atmospheric harvester configured for water and carbon dioxide capture is depicted. In FIG. 2A, exemplary atmospheric harvester is operating in adsorption mode. Surrounding air 202 is blown into atmospheric water harvesting unit 210. Moisture is captured by the water capture material in unit 210, and dry air is released from unit 210. Dry air 204 then enters atmospheric carbon dioxide harvesting unit 220, where carbon dioxide is captured by the carbon dioxide capture material in unit 220. Unit captures carbon dioxide and outputs air 205 with reduced moixture and carbon dioxide levels.

While FIG. 2A depicts an atmospheric harvester with two separate units 210 and 220, configured to capture moisture in unit 210 followed by carbon dioxide in unit 220, in other variations, the atmospheric harvester may be configured to capture carbon dioxide followed by moisture.

With reference to FIG. 2B, after adsorption occurs, atmospheric harvester 200 shifts to production mode. As depicted in FIG. 2B, heat 206 is introduced to both units 210 and 220. In atmospheric water harvesting unit 210, the water capture material therein desorbs water vapor. This water vapor is then condensed to produce liquid water 232. In atmospheric carbon dioxide harvesting unit 220, the carbon dioxide capture material therein desorbs carbon dioxide. This carbon dioxide may then be cooled. As depicted in FIG. 2B, carbon dioxide 234 can then be released from unit 220. Water 232 and carbon dioxide 234 generated can be introduced to a farming system.

In some variations, the atmospheric harvester may be configured to simultaneously desorb water vapor and carbon dioxide from their respective units. In other variations, the atmospheric harvester may be configured to desorb water vapor and carbon dioxide at different times.

A cooling process can be used to bring the effluent of water and carbon dioxide back to near-ambient temperature.

With reference again to FIG. 2B, heat 206 applied to units 210 and 220 may be from any suitable heating element or source. In some embodiments, the heating element is a heat pump. For example, the units in production mode may be heated using the hot side of a heat pump, with the cold side of the heat pump operating as a refrigeration system to condense the liquid water released, and cool off the hot carbon dioxide. In other embodiments, the units in production mode may be heated using resistive heating, direct sunlight, or hot air from solar collectors to desorb water and carbon dioxide, with water being condensed using a passive, air cooled heat exchanger. In yet other embodiments, desorption of water and carbon dioxide from the units may be accelerated using a vacuum pumps.

It should be understood that, in other embodiments, the atmospheric harvester includes one or more additional components. For example, in some variations, the atmospheric harvester includes a water collection unit, a control system, and power sources.

### Water and Carbon Dioxide Capture Materials

Any suitable materials that can capture water from air may be used as the water capture material. Similarly, any suitable materials that can capture carbon dioxide from air may be used as the carbon dioxide capture material. Such materials may be obtained from commercially available sources, or produced according to methods and techniques known in the art.

In some embodiments, the water capture material and the carbon dioxide capture material independently comprise metal-organic frameworks (MOPs). MOFs are porous materials that have repeating secondary building units (SBUs) connected to organic ligands. In some variations, the SBUs may include one or more metals or metal-containing complexes.

The units containing the water capture material and carbon dioxide capture material can be made of porous MOF material, MOP-coated substrates, or any combination thereof.

Water Capture Materials

In some embodiments, the water capture material can selectively capture water from the atmosphere.

In some variations, the water capture material is a MOF, in which the organic ligands have acid and/or amine functional group(s). In certain variations, the organic ligands have carboxylic acid groups. In other variations, the organic ligands have acid and/or amine functional group(s). In certain variations, the organic ligands have carboxylic acid groups.

Any suitable MOFs capable of adsorbing and desorbing water may be employed in the systems provided herein. Suitable MOF's may include those described in, for example, Kalmutzki et al., Adv. Mat., 30(37), 1704304 (2018); Furukawa et al., J. Am. Chem. Soc. 2014, 136, 4369-4381; Y. Tu et al, Joule, Vol 2, Issue 8(15), 1452-1475 (2018).

In some variations, the water capture material comprises:
MOF-303: Al(01-1)(HPDC), where HPDC is 1H-pyrazole-3,5-dicarboxylate;
CAU-10: Al(OH)(IPA), where IPA is isophthalate;
MOF-801: Zr₆O₄(OH)₄(fumarate)₆;
MOF-841: Zr₆O₄(OH)₄(MTB)₆(HCOO)₄(H₂O)₂;
Aluminum Fumarate: Al(OH)(fumarate);
MEL-160: Al(OH)(FDA), where FDA is 2,5-furandicarboxylate;
MIL-53: Al(OH)(TPA), where TPA is terephthalate; or
Aluminum Phosphate: AlPO4-LTA.

In some variations, the MOFs have pore sizes between about 0.5 nm about 1 nm, or between about 0.7 nm to about 0.9 nm. In certain variations, the MOFs have a hydrophilic pore structure. In certain variations, the MOFs have a hydrophilic pore structure comprising acid and/or amine functional groups. In certain variations, the MOFs have 1D channels that allow for reversible water adsorption.

In other variations, the water capture material is a desiccant material. Any suitable desiccant material may be used.

Any combinations of the water capture materials described herein may also be used.

In some embodiments, the water capture material is mixed with a binder to improve its properties for adhesion to a substrate.

Carbon Dioxide Capture Material

In some embodiments, the carbon dioxide capture material can selectively capture carbon dioxide from the atmosphere.

In some variations, the carbon dioxide capture material is a MOF, in which the organic ligands have amine functional groups, including primary amines, that can bind carbon dioxide molecules via chemisorption even in presence of water molecules.

Any suitable MOFs capable of adsorbing and desorbing carbon dioxide may be employed in the systems provided herein. Suitable MOFs may include those described in, for example, M. Ding, et al., Chem. Soc. Rev., 2019, 48, 2783-2828; A. M. Fracaroli, et al, J. Am. Chem. Soc., 2014, 136, 8863-8866; H. Li, et al., ChemSusChem., 2016, 9, 2832-2840.

In some variations, the carbon dioxide water capture material comprises:

IRMOF-74-III-CH₂NH₂: {Mg₂(2′-(aminomethyl)-3,3″-dioxido-[1,1′:4′,1″-terphenyl]-4,4″-dicarboxylate)};

IRMOF-74-III-(CH₂NH₂)₂: {Mg₂(2′,5′-bis(aminomethyl)-3,3″-dioxido-[1,1′:4′,1″-terphen-yl]-4,4″-dicarboxylate)};

mmen-Mg₂(dobpdc): Mg₂(dobpdc)(mmen)1.6(H₂O)_{0.4}, where dobpdc is 4,4′-dioxido-3,3′-biphenyldicarboxylate and mmen is N,N′-dimethylethylenediamine;

Mg₂(dobdc)(N₂H₄)_{1.8}: Mg₂(dobdc)(N₂H₄)_{1.8}, where dobpdc is 4,4′-dioxido-3,3′-biphenyldicarboxylate;

Cr-MIL-101-SO₃H-TAEA: Cr₃O(OH)(BDC-SO₃)(H₂O)₂(TAEA), where BDC-SO₃ is 2-sulfoterephthalate and TAEA is Tris(2-aminoethyl)amine; or

Cr-MIL-101-PEI-800: Cr₃O(OH)(BDC)(PEI-800), where PEI-800 is polyethylenimine, branched.

Any combinations of the carbon dioxide capture materials described herein may also be used.

In some embodiments, the carbon dioxide capture material is mixed with a binder to improve its properties for adhesion to a substrate.

In some variations, any combinations of the water and carbon dioxide materials described herein may be used.

In some embodiments, the relative mass of water and carbon dioxide capture materials in the system can be tailored to the humidity condition of a given region. For instance, very arid regions will necessitate an excess of water capture material, whereas relatively humid region will need a larger amount of carbon dioxide capture material.

In some variations, the amount of water and carbon dioxide capture materials may be pre-determined by the relative humidity and temperature level in the particular climate. This can be an installed feature of the system, such that amount of material in the system will not change throughout the operation.

### Other System Features and Components

Collection Units

In some embodiments, the atmospheric harvester is integrated into a farming system, as described in further detail. The water and carbon dioxide can be released directly into the farming system.

In other embodiments, the atmospheric harvester comprises at least one collection unit, configured to receive, and optionally store, the liquid water and carbon dioxide generated. In some variations, the collection unit is a storage tank.

Control System

In some embodiments, the atmospheric harvester includes a control system configured to monitor and control adsorption, desorption, and condensation. In some embodiments, the control system includes one or more sensors and one or more processor units.

In some embodiments, the control system monitors and controls the water and carbon dioxide harvesting based on environmental conditions such as temperature and humidity. In some embodiments, temperature or humidity sensors are placed inside or near the water and/or carbon dioxide harvesting units.

In some embodiments, the control system monitors and controls the atmospheric harvester to maximize the total water and/or carbon dioxide captured over multiple adsorption and desorption cycles, as opposed to optimizing the adsorption or desorption amounts individually.

Power Sources

In some variations, the atmospheric harvester further include one or more solar power source(s). In certain variations, the systems further include photovoltaic (PV) cells or passive solar captors, or a combination thereof

### Farming Systems

In certain aspects, provided is an integrated farming system, comprising: an atmospheric harvester as described herein integrated to release water and carbon dioxide captured from surrounding air into a farming system. In some embodiments, the farming system is a hydroponic farming system. In other embodiments, the farming system is a vertical farming system. In certain variations of the foregoing, the farming system is in a sealed enclosure, or the farming system is in a sealed environment.

One of skill in the art would appreciate that another important feature of photosynthesis is the production of oxygen, as seen in Eq(1) above. In a sealed farming system, oxygen would accumulate and plants would ultimately not survive. Thus, in some variations, the farming systems described herein further comprise an element configured to reduce or eliminate oxygen from the air inside the farming system.

In some variations, the farming system further comprises an oxygen reduction unit that evacuates excess oxygen and equilibrates the nitrogen:oxygen ratio with the outside air. In certain variations, the oxygen reduction unit comprises an oxygen-permeable membrane. In one variation, the use of an oxygen exchanger is shown schematically in FIG. 3 in exemplary vertical farming system 300. System 300 includes vertical farm 310 connected to oxygen exchanger 320 (which can also be referred to as an oxygen reduction unit). Oxygen exchanger 320 includes oxygen-permeable membrane 322. Oxygen-rich air 312 is directed from farm 310 into oxygen exchanger 320. This oxygen-rich air may include a mix of nitrogen and oxygen. The oxygen gas is pushed through membrane 322 to the environment, and the rest of gas mixture 314 is directed back to farm 310. On the other side, the environmental air is circulated to remove excess oxygen through the membrane. Oxygen-poor air 324 is directed from the environment, and is enriched with oxygen and removed as output 326.

In other variations, the farming system can utilize living organisms to evacuate excess oxygen and equilibrate the nitrogen:oxygen ratio with the outside air. In some variation, the farming system comprises animals with a metabolism that is the reverse of Eq(1). In some embodiments, the atmospheric harvesters described herein can be used with farming systems, such as exemplary farming system 400 as depicted in FIG. 4. In system 400, oxygen reduction or elimination is achieved using animals. Animals 420 present in farming system 400 consume oxygen 402 that is produced by crops 410 in farming system 400, and in turn produce carbon dioxide 404 that the plants need to grow. In such a variation, animals feed with the crop production from the farming system, and serve as a source of proteins to complement crop production. Suitable animals may include domesticated farm animals, such as cows, goats, sheep, and chicken. These animals may also have efficient protein and fat production. In other variations, the farming system can include insects or any living organism (e.g., nematods, bacteria) with an oxygen-consuming metabolism that can also produce proteins.

In other variations, the farming system can utilize a source of fuel to convert oxygen to carbon dioxide, using combustion. In some embodiments, the atmospheric harvesters described herein can be used with farming systems, such as exemplary vertical farming system depicted in FIG. 5. System 500 includes vertical farm 510 connected to combustion chamber 520. Oxygen-rich stream 512 is directed from vertical farm 510 to combustion chamber 520, which uses fuel 522 (such as biomass, coal etc.) to convert oxygen to carbon dioxide. Carbon dioxide-rich stream 514 is then directed from combustion chamber 520 back to vertical farm 510. In one variation, the fuel comprises biomass (e.g., wood or grass) that could be available near the farm. In another variation, the fuel comprises fossil fuel (e.g., natural gas, crude oil or its derivatives) that is often available in arid regions of the world.

What is claimed is:

1. An atmospheric harvester, comprising: at least one unit containing water capture material, carbon dioxide capture material, or both, from surrounding air,
wherein, in adsorption mode:
the at least one unit containing water capture material is configured to adsorb moisture from the air, and
the at least one unit containing carbon dioxide capture material is configured to adsorb carbon dioxide from the air; and
wherein, in production mode:
the at least one unit containing water capture material is configured to desorb water vapor form the water capture material,
the at least one unit containing carbon dioxide capture material is configured to desorb carbon dioxide from the carbon dioxide capture material, and
the atmospheric harvester is configured to condense the water vapor into liquid water, and cool the carbon dioxide.

2. The atmospheric harvester of claim 1, wherein the at least one unit comprises:
at least one atmospheric water harvesting unit containing the water capture material, and
at least one atmospheric carbon dioxide harvesting unit containing carbon dioxide capture material.

3. The atmospheric harvester of claim 2, wherein, in adsorption mode, the at least one atmospheric water harvesting unit is configured to adsorb moisture from surrounding air and release dry air, and the at least one atmospheric carbon dioxide harvesting unit is configured to adsorb carbon dioxide from the released dry air.

4. The atmospheric harvester of claim 2, wherein, in adsorption mode, the at least one atmospheric carbon dioxide harvesting unit is configured to adsorb carbon dioxide from surrounding air and release carbon dioxide-depleted air, and the at least one atmospheric carbon dioxide harvesting unit is configured to adsorb moisture from the released carbon dioxide-depleted air.

5. The atmospheric harvester of claim 2, wherein, in adsorption mode, the at least one atmospheric carbon dioxide harvesting unit and the at least one atmospheric carbon dioxide harvesting unit are configured to simultaneously adsorb moisture and carbon dioxide, respectively, from the surrounding air.

6. The atmospheric harvester of claim 1, wherein the at least one unit comprises:
at least one unit containing a mixture of water capture material and carbon dioxide capture material, configured to simultaneously adsorb water and carbon dioxide from surrounding air in adsorption mode.

7. The atmospheric harvester of any one of claims 1 to 6, wherein, in production mode, the at least one unit is configured to simultaneously generate water and carbon dioxide.

8. The atmospheric harvester of any one of claims 1 to 7, wherein, in production mode, the at least one unit is heated by a heating element or source.

9. The atmospheric harvester of any one of claims 1 to 7, wherein, in production mode, the at least one unit is heated by a heat pump, or heated using resistive heating, direct sunlight, or hot air from solar collectors, or any combination thereof.

10. The atmospheric harvester of any one of claims 1 to 7, further comprising: a heating element, and a condensing unit,
wherein in production mode,
the heating element is configured to heat the at least one unit to induce desorption of water vapor from the water capture material, and to induce desorption of carbon dioxide from the carbon dioxide capture material; and
the condensing unit is configured to condense the water vapor and to cool the carbon dioxide.

11. The atmospheric harvester of any one of claims 1 to 7, further comprising a heating element having a hot side and a cold side,
wherein, in production mode:
the heating element is configured, from the hot side, to heat the at least one unit containing water capture material to induce desorption of water vapor from the water capture material, and heat the at least one unit containing carbon dioxide capture material to induce desorption of carbon dioxide from the carbon dioxide capture material; and
the heating element is configured, from the cold side, to condense the water vapor to liquid water, and to cool the carbon dioxide.

12. The atmospheric harvester of any one of claims 1 to 11, further comprising a vacuum pump, configured to accelerate desorption of water vapor and carbon dioxide in production mode.

13. The atmospheric harvester of any one of claims 1 to 12, wherein the water capture material and the carbon dioxide capture material independently comprise metal-organic framework.

14. The atmospheric harvester of any one of claims 1 to 12, wherein the water capture material comprises MOP-303, CAU-10, MOF-801, MOF-841, Aluminum Fumarate, MIL-160, MIL-53, or Aluminum Phosphate, or any combination thereof.

15. The atmospheric harvester of any one of claims 1 to 12, wherein the carbon dioxide capture material comprises IRMOF-74-III-C₂NH₂, IRMOF-74-III-(CH₂NH₂)₂, mmen-Mg₂(dobpdc), Mg₂(dobdc)(N₂H₄)_{1.8}, Cr-MIL-101-SO₃H-TAEA, or Cr-MIL-101-PEI-800, or any combination thereof.

16. The atmospheric harvester of any one of claims 1 to 13, further comprising: a control system, configured to monitor and control adsorption, desorption, and condensation in the at least one unit containing water capture material and/or carbon dioxide capture material.

17. An integrated farming system, comprising:
an atmospheric harvester according to any one of claims 1 to 16, configured to release water and carbon dioxide harvested from surrounding air into a farming system.

18. The system of claim 17, further comprising:
an oxygen reduction unit, configured to evacuate excess oxygen in the farming system, and to equilibrate the nitrogen:oxygen ratio in the farming system with surrounding air.

19. The system of claim 18, wherein the oxygen reduction unit comprises an oxygen-permeable membrane.

20. The system of claim 18, wherein the oxygen reduction unit comprises living organisms with oxygen-consuming metabolism and that produce proteins.

21. The system of claim 18, wherein the oxygen reduction unit comprises fuel, wherein the oxygen reduction unit is configured to convert oxygen to carbon dioxide by combustion.

22. A method of harvesting water and carbon dioxide from surrounding air using an atmospheric harvester comprising at least one unit containing water capture material, carbon dioxide capture material, or both, from surrounding air, the method comprising:
adsorbing moisture from air in the at least one unit containing water capture material, and adsorbing carbon dioxide from air in the at least one unit containing carbon dioxide capture material;
desorbing water vapor from the water capture material in the at least one unit containing water capture material, and desorbing carbon dioxide from the carbon dioxide capture material in the at least one unit containing carbon dioxide capture material;
condensing the water vapor to produce liquid water; and
cooling the carbon dioxide.

23. A method of harvesting water and carbon dioxide from surrounding air using an atmospheric harvester according to any one of claims 1 to 16, the method comprising:
drawing air into the at least one unit containing water capture material, wherein moisture is adsorbed by the water capture material;
drawing air into the at least one unit containing carbon dioxide capture material, wherein carbon dioxide is adsorbed by the carbon dioxide capture material;
heating the at least one unit to desorb water vapor from the water capture material and carbon dioxide from the carbon dioxide capture material;
condensing the water vapor to produce liquid water; and
cooling the carbon dioxide.

24. A method of harvesting water and carbon dioxide from surrounding air using an atmospheric harvester according to any one of claims 1 to 16, the method comprising:
drawing surrounding air into the at least one unit containing water capture material, wherein moisture is adsorbed by the water capture material and dry air is released;
drawing the dry air released into the at least one unit containing carbon dioxide capture material, wherein carbon dioxide is adsorbed by the carbon dioxide capture material;
heating the at least one unit to desorb water vapor from the water capture material and carbon dioxide from the carbon dioxide capture material;
condensing the water vapor to produce liquid water; and
cooling the carbon dioxide.

25. A method of harvesting water and carbon dioxide from surrounding air using an atmospheric harvester according to any one of claims 1 to 16, the method comprising:
drawing surrounding air into the at least one unit containing carbon dioxide capture material, wherein carbon dioxide is adsorbed by the carbon dioxide capture material and carbon dioxide depleted air is released;
drawing the carbon dioxide depleted air released into the at least one unit containing water capture material, wherein moisture is adsorbed by the water capture material;
heating the at least one unit to desorb water vapor from the water capture material and carbon dioxide from the carbon dioxide capture material;
condensing the water vapor to produce liquid water; and
cooling the carbon dioxide.

26. A method of harvesting water and carbon dioxide from surrounding air using an atmospheric harvester according to any one of claims 1 to 16, the method comprising:
drawing surrounding air into the at least one unit containing a mixture of water capture material and carbon dioxide capture material, wherein moisture is adsorbed by the water capture material and wherein carbon dioxide is adsorbed by the carbon dioxide capture material;
heating the at least one unit to desorb water vapor from the water capture material and carbon dioxide from the carbon dioxide capture material;
condensing the water vapor to produce liquid water; and
cooling the carbon dioxide.

27. The method of any one of claims 22 to 26, wherein the at least one unit is heated to simultaneously desorb water vapor from the water capture material and carbon dioxide from the carbon dioxide capture material.

28. The method of any one of claims 22 to 27, wherein the water capture material and the carbon dioxide capture material independently comprise metal-organic framework.

29. The method of any one of claims 22 to 27, wherein the water capture material comprises MOF-303, CAU-10, MOF-801, MOF-841, Aluminum Fumarate, MIL-160, MIL-53, or Aluminum Phosphate, or any combination thereof.

30. The method of any one of claims 22 to 27, wherein the carbon dioxide capture material comprises IRMOF-74-III-CH₂NH₂, IRMOF-74-III-(CH₂NH₂)₂, mmen-Mg₂(dobpdc), Mg₂(dobdc)(N₂H₄)_{1.8}, Cr-MIL-101-SO₃H-TAEA, or Cr-MIL-101-PEI-800, or any combination thereof.

31. A method for firming, comprising:
providing water and carbon dioxide harvested from surrounding air according to the method of any one of claims 22 to 30 to a farming system; and
growing crops in the farming system.

32. The method of claim 31, further comprising:
reducing or eliminating oxygen from air inside the farming system.
